(19) United States
(12) Patent Application Publication
(10) Pub. No.: US 2012/0081207 A1
(43) Pub. Date: Apr. 5, 2012

(54) APPLICATION LAUNCHING IN CONJUNCTION WITH AN ACCESSORY

(75) Inventors: Shyam Toprani, Los Altos, CA (US); Paul Holden, San Francisco, CA (US); Emily Clark Schubert, San Jose, CA (US); Thomas Alsina, Cupertino, CA (US); Scott Forstall, Cupertino, CA (US)

(73) Assignee: Apple Inc., Cupertino, CA (US)

(21) Appl. No.: 13/085,952

(22) Filed: Apr. 13, 2011

Related U.S. Application Data
(60) Provisional application No. 61/388,560, filed on Sep. 30, 2010.

(51) Int. Cl. G05B 19/02

(52) U.S. Cl. 340/4.3

(57) ABSTRACT

Embodiments of the present invention provide systems and methods for launching an application in response to a launch request from an accessory. In some embodiments, the mobile computing device can determine whether it is in a state that allows launching of an application and/or can determine whether the application or application type requested in the launch command is available for launching. In response to the request, and if the mobile computing device is capable, the mobile computing device can launch the application. The mobile computing device can also send a positive acknowledgment message to the accessory indicating that the application may be launched. An open communication session message may also be sent to the accessory. In response thereto the accessory can open a communication session and interoperate with the application.

### CROSS-REFERENCES TO RELATED APPLICATIONS

The present application claims the benefit and priority under 35 U.S.C. 119(e) of U.S. Provisional Application No. 61/388,560 (Atty. Docket No. 20750P-017400US), filed Sep. 30, 2010, entitled APPLICATION AUTO-LAUNCH IN CONJUNCTION WITH AN ACCESSORY, the entire contents of which are incorporated herein by reference for all purposes,

### BACKGROUND

The present disclosure relates generally to communication between an accessory and a mobile computing device and in particular to accessory requests to launch applications on a mobile computing device.

Mobile computing devices have become ubiquitous. Various companies have created mobile computing devices, such as the iPhone™, iPod Touch™, iPad™, various BlackBerry® devices, and smart phones compatible with Google's Android™ platform, to name a few. Mobile computing devices often include web browsers, word processors, email applications, maps, telephone services, games, audio applications, video applications, etc. Moreover, accessories have also been created for use with mobile computing devices. Some accessories can be created to interoperate with a specific application or group of applications that execute on a mobile computing device.

### BRIEF SUMMARY

Embodiments of the invention provide techniques for launching an application on a mobile computing device that is communicatively coupled with an accessory. In one set of embodiments, an accessory can send a command to a mobile computing device for launching an application on the mobile computing device. In response, the mobile computing device can send an acknowledgment message to the accessory indicating that the application may be launched. A communication session can then be opened for facilitating communication between the accessory and the mobile computing device.

The following detailed description together with the accompanying drawings will provide a better understanding of the nature and advantages of the present invention.

### BRIEF DESCRIPTION OF THE DRAWINGS

FIG. 1 shows a mobile computing device coupled with two accessories using a wired and wireless communication channel according to some embodiments of the invention.

FIG. 2 shows a block diagram of a mobile computing device and a block diagram of an accessory coupled together according to one embodiment of the invention.

FIG. 3 is a flowchart of a process for launching an application that occurs on a mobile computing device according to some embodiments of the invention.

FIG. 4 is a flowchart of a process for an accessory to request launching of an application at a mobile computing device according to some embodiments of the invention.

FIG. 5 is another a flowchart of a process for launching an application that occurs on a mobile computing device according to some embodiments of the invention.

FIG. 6 is another flowchart of a process for an accessory to request launching of an application at a mobile computing device according to some embodiments of the invention.

FIG. 7 is another flowchart of a process for launching an application that occurs on a mobile computing device according to some embodiments of the invention.

FIG. 8 is another flowchart of a process for an accessory to request launching of an application at a mobile computing device according to some embodiments of the invention.

### DETAILED DESCRIPTION

Various embodiments of the invention are directed toward processes and systems that can be used by an accessory to request that a mobile computing device execute or launch an application. For example, an accessory may be developed to work with a specific application that is executed by a mobile computing device. Rather than wait for a user to open and/or execute the application at the mobile computing device, the accessory can send a command to the mobile computing device requesting that the mobile computing device execute the application. In some cases the mobile computing device can control whether to launch the application or not, determine whether the mobile computing device is in a state that can allow a new application to launch, or the like. Thus, in some embodiments, the accessory can request that an application be launched and the request can be denied or approved by the mobile computing device. The mobile computing device can control when and how the request is handled.

In some embodiments, the launch command sent to the mobile computing device can include information indicating either a specific application or an application type. The mobile computing device can then determine, based on this information, which applications to launch. In one set of embodiments, in response to the request, the accessory can wait for the opening of a communication channel. Once a communication channel has been opened, the application and the accessory can interoperate.

In some embodiments, an accessory can request application information from the mobile computing device. This can be done, for example, during an initialization phase where device capabilities can be exchanged. In response, the mobile computing device can send a listing of available applications. Using this listing, the accessory can send a launch request that includes a bit mask that corresponds to each of the available applications. A bit in the bit mask can be asserted indicating that the corresponding application in the listing of applications be launched.

A launch command can include a number of data elements—for example, the name of a specific application; an application type; a genus of applications; the name of the accessory, which can be used to look up application types in a lookup table; a bit mask that indicates a type of application or a specific application to be launched; a communication protocol that will be used for communication; or an identifier of the accessory making the request; a code corresponding to the application type; or any other information that can identify an application or application type.

Because the mobile computing device controls which applications are launched and which are not launched, accessory control of the mobile computing device can be tempered. But despite this control, accessories can still request that the mobile computing device launch an application. Thus, embodiments of the invention strike a balance between total control of application launching and accessory flexibility to launch an application at the mobile computing device.

Mobile Computing Devices and Accessories

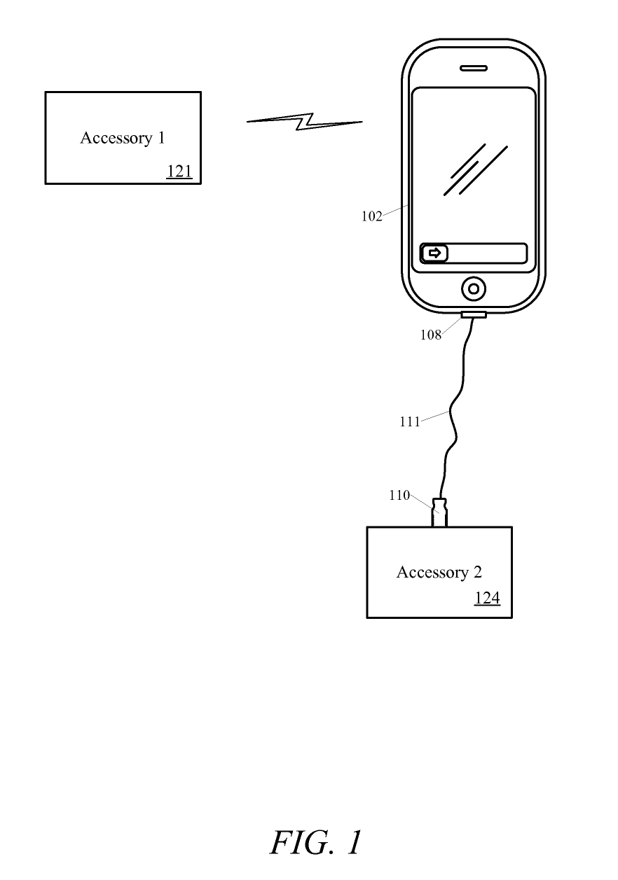

FIG. 1 shows a mobile computing device 102 coupled with accessory 121 and accessory 124. Cable 111 is used to couple mobile computing device 102 with accessory 124. Cable 111 can include connector 108 to connect with mobile computing device 102 and connector 110 to connect with accessory 124. Accessory 121 is wirelessly coupled with mobile computing device 102.

The mobile computing device can be any type of mobile computing and/or communication device without limitation. For example, an iPod Touch™, an iPhone™, iPad ™, an Android compatible device and/or a Blackberry device can be used. Moreover, mobile computing device 102 can provide media player capability, networking, web browsing, email, word processing, data storage, application execution, and/or any other computing or communication functions.

Accessory 113 can be any device capable of communicating with mobile computing device 102 such as, for example, an external speaker system; an external video device; a multimedia device; a consumer electronic device; a test instrument; a home appliance (e.g., refrigerator, coffee maker, environmental control system, or dishwasher); exercise equipment; a security system; a home or office automation system; a camera; a user input device (e.g., keyboard, mouse, game controller); a measurement device; a medical device (e.g., glucose monitor or insulin monitor); a point of sale device; an automobile; an automobile accessory (e.g., a car stereo system or car navigation system); a radio (e.g., FM, AM and/or satellite); an entertainment console on an airplane, bus, train, or other mass transportation vehicle; etc. Any type of device that can be used in conjunction with a mobile computing device can be used as an accessory device.

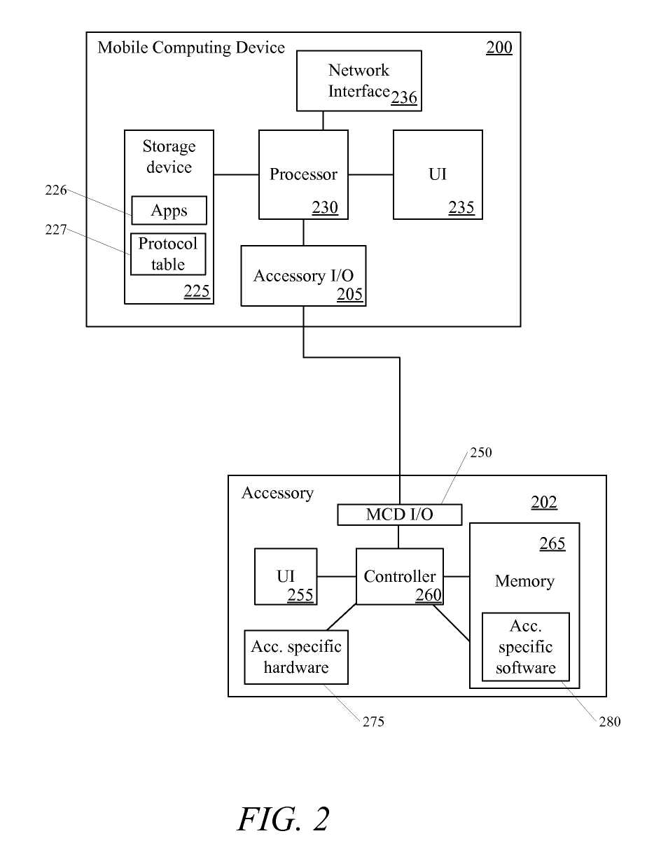

FIG. 2 shows a block diagram of mobile computing device 200 (e.g., implementing mobile computing device 102 of FIG. 1) coupled with accessory 202 (e.g., implementing accessory 121 or accessory 124) according to one embodiment. Mobile computing device 200 can include processor 230, storage device 225, user interface (UI) 235, network interface 236, and accessory input/output (I/O) interface 205.

Processor 230, which can be implemented as one or more integrated circuits (including, e.g., a conventional microprocessor or microcontroller), can control the operation of mobile computing device 200. For example, in response to user input signals provided by user interface 235, processor 230 can perform various tasks such as selecting and playing media assets that may be stored in stored in storage device 225; accessing various networks (e.g., a mobile telephone network, the Internet, local area network, or the like) to send and/or retrieve data using network interface 236; executing various application programs (Apps) 226 residing on storage device 225; and so on. Processor 230 can also manage communication with accessories via accessory I/O interface 205.

User interface 235 can include input controls such as a touch pad, touch screen, scroll wheel, click wheel, dial, button, keypad, microphone, etc., as well as output devices such as a display screen, indicator lights, speakers, headphone jacks, etc., together with supporting electronics (e.g., digital-to-analog or analog-to-digital converters, signal processors or the like). A user can operate the various input controls of user interface 235 to invoke the functionality of mobile computing device 200 and can also view and/or hear output from mobile computing device 200 via user interface 235.

Storage device 225 may be implemented, e.g., using disk, flash memory, or any other non-volatile storage medium. Storage device 225 can store application programs 226 that are executable by processor 230, system programs and other program code (not explicitly shown), and various data such as protocol table 227 that can be used in managing communication with various accessories. In some embodiments, storage device 225 can also store media assets such as audio, video, still images, or the like, that can be played by mobile communication device 200, along with metadata describing the media assets (e.g., asset name, artist, title, genre, etc.), playlists (lists of assets that can be played sequentially or in random order), and the like. Storage device 225 can also store any other type of information such as information about a user's contacts (names, addresses, phone numbers, etc.); scheduled appointments and events; notes; and/or other personal information.

Application programs (also referred to herein as “applications” or “apps”) 226 can include any program executable by processor 230. For example, in one set of embodiments, an application can be a program that includes a user interface for enabling interaction with a user. In other embodiments, an application can be a process that runs in the background, such as a daemon. In some embodiments, certain applications can be installed on mobile computing device 200 by its manufacturer, while other applications can be installed by a user. Examples of application programs can include video game programs, personal information management programs, programs for playing media assets and/or navigating the media asset database, programs for controlling a telephone interface to place and/or receive calls, and so on. Certain application programs 226 may provide communication with and/or control of accessory 202, and certain application programs 226 may be responsive to control signals or other input from accessory 202; examples are described below.

Network interface 236 can provide an interface to one or more communication networks. For example, network interface 236 can incorporate a radio-frequency (RF) transceiver and suitable components for communicating via a mobile communication network such as a mobile telephone network. Additionally or instead, network interface 236 can incorporate a wireless connection to the Internet (e.g., a WiFi transceiver, 3G transceiver or the like), to a personal area network (e.g., a Bluetooth network), or any other network. In still other embodiments, a wired network connection (e.g., Ethernet) may be provided. In some embodiments, the same hardware can be used to support connections to multiple networks; thus, network interface 236 can include analog-to-digital and/or digital-to-analog circuitry, baseband processing components (e.g., codecs, channel estimators, and the like), modulators, demodulators, oscillators, amplifiers, transmitters, receivers, transceivers, internal and/or external antennas, and so on. In some embodiments, some operations associated with network connectivity can be implemented entirely or in part as programs executed on processor 230 (e.g., encoding, decoding, and/or other processing in the digital domain), or a dedicated digital signal processor can be provided.

Accessory I/O interface 205 can include a number of signal paths configured to carry various signals between mobile computing device 200 and accessory 202. In one embodiment, accessory I/O interface 205 includes a 30 pin connector corresponding to the connector used on iPod® and iPhone™ products manufactured and sold by Apple Inc.; other connectors can also be used. Alternatively or additionally, accessory I/O interface 205 can include a wireless interface (e.g., Bluetooth or the like).

In some embodiments, mobile computing device 200 can also use accessory I/O interface 205 to communicate with a host computer (not shown) that executes an asset management program that can provide media and/or applications for a mobile computing device (for example, iTunes® or Microsoft's application store). The asset management program can enable a user to add media assets and/or applications to mobile computing device and/or remove media assets from mobile computing device 200. The user can update metadata associated with media assets on mobile computing device 200. In some embodiments, the user can also interact with the asset management program to create and update playlists and/or applications as well as other documents. In one embodiment, the host computer maintains a master database of media assets and/or applications and can access other databases, for example, through the Internet (including associated metadata and playlists), and the asset management program synchronizes the master database with the database maintained on storage device 225 of mobile computing device 200 automatically whenever mobile computing device 200 connects to the host computer. In other embodiments, mobile computing device 200 can use network interface 236 to communicate with a host computer and/or directly with various other servers to acquire applications, media assets and/or other data.

Accessory 202 can include controller 260, user interface 255, mobile computing device I/O interface 250, memory 265, and accessory specific hardware 275.

Mobile computing device I/O interface 250 can include a number of signal paths configured to carry various signals between accessory 202 and mobile computing device 200. In one embodiment, mobile computing device I/O interface 250 can include a connector adapted to mate with a connector (e.g. a 30-pin connector) used on iPad™, iPod® and iPhone™ products manufactured and sold by Apple Inc. Other connectors can also be used; for example, mobile computing device I/O interface 250 can include a standard USB or FireWire connector or the like. Alternatively or additionally, mobile computing device I/O interface 250 can include a wireless interface (e.g., Bluetooth or the like).

Controller 260 can include, e.g., a microprocessor or microcontroller executing program code to perform various functions such as digital audio decoding, analog or digital audio and/or video processing, processing of user input, controlling of accessory functionality and the like. Controller 260 can also manage communication with a mobile computing device via mobile computing device I/O interface 250.

User interface 255 can include input controls, such as a touch pad, touch screen, scroll wheel, click wheel, dial, button, keypad, microphone, probes, etc., as well as output devices, such as a video screen, indicator lights, speakers, headphone jacks or the like, together with supporting electronics (e.g., digital-to-analog or analog-to-digital converters, signal processors or the like). A user can operate the various input controls of user interface 255 to invoke the functionality of accessory 202 and can view and/or hear output from accessory 202 via user interface 255. In addition, in some embodiments, a user can operate mobile computing device 200 (or applications executing thereon) via accessory user interface 255.

Memory 265 can be implemented using any type of memory, disk, or other storage medium that can store program code for controller 260 and/or data. For example, memory 265 can store accessory specific software 280 that can provide instructions for controller 260 to interact with accessory specific hardware 275, and/or user interface 255. In some embodiments, accessory 202 can receive information (e.g., user input, metadata, and/or application data) from mobile computing device 200, and such information can also be stored in memory 265.

Accessory specific hardware 275 can represent any hardware needed to enable desired functionality of accessory 202. For example, accessory specific hardware 275 can include one or more data gathering devices, such as any type of sensor or meter. In some embodiment, accessory specific hardware 275 can include an electrical meter that generates data representing electrical characteristics (resistance, voltage difference, or the like); a light sensor that detects light and/or patterns of light; a motion sensor; a temperature sensor; a humidity sensor; a pressure sensor; a chemical sensor that responds to the presence of selected chemicals (e.g., potentially toxic gases such as carbon monoxide); and so on. Accessory specific hardware 275 can also include one or more medical device such as a glucose meter, respiratory meter, heart rate and/or heart function monitor, blood pressure monitor, or the like.

In some embodiments, accessory specific hardware 275 that includes a data-gathering device can provide one or more electrical signals (e.g., voltage, resistance, and/or current) that correspond to or represent the physical data. Analog and/or digital signals in a variety of formats may be used. Accessory specific hardware 275 can also include signal processing components that process the signal before sending it to controller 260; in some embodiments, accessory specific hardware 275 can send the electrical signal directly to controller 260, which can process the signal. Further, signals representing data gathered by accessory specific hardware 275 can be sent (with or without processing by controller 260) to an application executing on mobile computing device 200, e.g., using an application protocol as described below; thus an application executing on mobile computing device 200 can also process data gathered using accessory specific hardware 275.

In some embodiments, accessory specific hardware 275 can include one or more computer-controllable devices. Examples of computer-controllable devices include motors, actuators, lights, cameras, valves, speakers, display screens, printers, and/or any other equipment that is controllable by controller 260. In some embodiments, an application executing on mobile computing device 200 can send control signals to accessory 202, and controller 260 can operate accessory specific hardware 275 in response to the control signals.

In some embodiments, accessory specific hardware 275 can include components of user interface 255. In some embodiments, accessory specific hardware 275 can include network and/or communication interfaces. In other embodiments, accessory specific hardware 275 can include a communication interface to a personal area network. In still other embodiments, accessory specific hardware 275 can include a telephone interface, GSM, CDMA, and/or other voice and/or data network interfaces. Accessory specific hardware 275 can encompass any hardware component for which interoperability with a mobile computing and/or communication device may be desirable.

The system configurations and components described herein are illustrative and that variations and modifications are possible. The mobile computing device and/or accessory may have other capabilities not specifically described herein. While accessory 202 and mobile computing device 200 are described herein with reference to particular blocks, it is to be understood that the blocks are defined for convenience of description and are not intended to imply a particular physical arrangement of component parts. Further, the blocks need not correspond to physically distinct components.

Accessory I/O interface 205 of mobile computing device 200 and mobile computing device I/O interface 250 of accessory 202 allow mobile computing device 200 to be connected to accessory 202 and subsequently disconnected from accessory 202. As used herein, mobile computing device 200 and accessory 202 are “connected” whenever a communication channel between accessory I/O interface 205 and mobile computing device I/O interface 250 is open and are “disconnected” whenever the communication channel is closed. Connection can be achieved by physical attachment (e.g., between respective mating connectors of mobile computing device 200 and accessory 202), by an indirect attachment such as a cable, or by establishing a wireless communication channel. Similarly, disconnection can be achieved by physical detachment, disconnecting a cable, powering down accessory 202 or mobile computing device 200, or closing the wireless communication channel. Thus, a variety of communication channels may be used, including wired channels such as Universal Serial Bus (“USB”), FireWire (IEEE 1394 standard), or universal asynchronous receiver/transmitter (“UART”), or wireless channels such as Bluetooth (a short-range wireless communication standard developed by the Bluetooth SIG and licensed under the trademark Bluetooth®), WiFi (adhering to any of the IEEE 802.11 family standards), wireless personal area network, infrared, or the like. In some embodiments, communication can occur using both a wired and a wireless channel. In some embodiments, multiple communication channels between a mobile computing device and an accessory can be open concurrently, or a mobile computing device can be concurrently connected to multiple accessories, with each accessory using a different communication channel.

Regardless of the particular communication channel, as long as mobile computing device 200 and accessory 202 are connected to each other, the devices can communicate by exchanging commands and data as specified by an accessory communication protocol. The accessory communication protocol can define a format for sending messages between mobile computing device 200 and accessory 202. For instance, the accessory communication protocol may specify that each message is sent in a packet with a header, a payload, and/or a tail. The header can provide basic information such as a start indicator, length of the packet, and a command to be processed by the recipient, while the payload provides any data associated with the command; the amount of associated data can be different for different commands, and some commands may provide for variable-length payloads. The packet can also include a tail that may provide error-detection or error-correction codes, e.g., as known in the art, and/or other information as desired. In various embodiments, the accessory communication protocol can define specific commands to indicate an action to be taken by the recipient; to signal completion of a task, change of state, or occurrence of an error; and/or to identify the nature of the associated data. In some embodiments, the commands may be defined such that any particular command is valid in only one direction.

The accessory communication protocol can also specify one or more physical transport links usable for transmitting signals between devices. For example, the transport link can be a USB link, a UART link, a FireWire link, a Bluetooth link, a WiFi link, a parallel link, a serial link, etc. At this level, the accessory communication protocol can specify, e.g., start bytes, sync bytes, stop bytes, and/or other auxiliary signals. In some embodiments, the accessory communication protocol can provide for multiple alternative transport links; thus a single mobile computing device can support communication over a variety of physical links including wired and/or wireless links.

The accessory communication protocol can define a number of “lingoes,” where a “lingo” refers generally to a group of related commands that can be supported (or unsupported) by various classes of accessories. In one embodiment, a command can be uniquely identified by a first byte identifying the lingo to which the command belongs and a second byte identifying the particular command within the lingo. Other command structures may also be used. It is not required that all accessories, or all mobile computing devices to which an accessory can be connected, support every lingo defined within the accessory communication protocol or every command of a particular lingo (for instance, different devices might use different versions of a given lingo or they might only use some of the features of that lingo).

In some embodiments, every accessory 202 and every mobile computing device 200 that are designed to interoperate with each other support at least a “general” lingo that includes commands common to all such devices. The general lingo can include commands enabling the mobile computing device and the accessory to identify themselves to each other and to provide at least some information about their respective capabilities, including which (if any) other lingoes each supports and which capabilities of the other device each intends to use while connected.

The general lingo can also include authentication commands that the mobile computing device can use to verify the purported identity and capabilities of the accessory (or vice versa), and the accessory (or mobile computing device) may be blocked from invoking certain commands or lingoes if the authentication is unsuccessful. For example, an authentication manager (not shown) within mobile computing device 200 can communicate with an authentication controller (also not shown) within accessory 202 to perform an authentication procedure, e.g., based on public key cryptography and a store of digital certificates maintained within the authentication manager of mobile computing device 200.

The general lingo or another lingo of the accessory communication protocol can also include “tunnel” commands that allow an exchange of arbitrary information between an application 226 executing on mobile computing device 200 and accessory 202. For example, a TunnelToAcc command can be defined as being sendable by mobile computing device 200 to accessory 202. The payload of this command can be any data, control signals, or other information that an application 226 executing on mobile computing device 200 can generate and send to accessory 202. Similarly, a TunnelToHost command can be defined as being sendable by accessory 202 to mobile computing device 200. The payload of this command can be any data, control signals, or other information that accessory 202 can generate and send to an application 226 executing on mobile computing device 200. These tunnel commands can be defined such that the accessory communication protocol is agnostic as to the payload content. Examples of techniques for managing communication such that a particular application sends data, control signals or other information only to accessories capable of processing it (and vice versa) are described below.

In some embodiments, the accessory can communicate with an API associated with one or more applications at the mobile computing device using the application communication protocol. For example, such communication can use the “tunnel” command discussed above. In some embodiments, the accessory can communicate with an API associated with one or more applications using the accessory communication protocol. In other embodiments, the accessory can also communicate with the mobile computing device operating system using either or both of the accessory communication protocol and/or the application communication protocol. Thus, embodiments disclosed herein can be used to facilitate communication between an accessory and an application, API, and/or operating system at the mobile computing device using either or both of an application communication protocol and/or an accessory communication protocol.

An accessory communication protocol supported by a mobile computing device and an accessory can include various other lingoes, such as a simple remote lingo that allows the accessory to send a command indicating a function of the mobile computing device to be invoked, a remote user interface lingo that can be used to communicate commands and data related to replicating all or part of a user interface of the mobile computing device on the accessory (thereby supporting a more advanced remote control), a tuner lingo that allows a user to control a tuner accessory by operating the mobile computing device, a storage lingo that allows the accessory to store data on the mobile computing device, and so on. Any lingo or combination of lingoes or other commands or groups of commands can be used in connection with embodiments described herein.

It will be appreciated that the accessory communication protocol described herein is illustrative and that variations and modifications are possible. Specific commands described herein can be replaced with other commands or combination of commands or other types of messages and formats. In addition, it is not required that all of the commands and operations described herein be supported by any particular mobile communication device or accessory.

Application 226 executing on mobile computing device 200 and accessory 202 can exchange arbitrary data, control signals, and/or other information (also referred to herein as “messages”). These messages can relate to a wide variety of circumstances. For example, messages relating to user input events, detected external conditions, received data or any other events or conditions that may occur at mobile computing device 200 can be communicated to accessory 202. Conversely, messages relating to user input events, detected external conditions, received data or other events or conditions that may occur at accessory 202 can be communicated to mobile computing device 200.

For example, in some embodiments, mobile computing device 200 can process input events from a user, for example, through user interface 255, such as touch screen events, button presses, scroll wheel events, etc. Mobile computing device 200 can provide data representative of input events to an application running on mobile computing device 200, to accessory 202, or to both. Accessory 202 can interpret such data as input for controlling, for example, accessory specific hardware 275 and/or for processing at controller 260. For example, touch screen data can be collected by mobile computing device 200 for use by an application, accessory 202, or both; in some embodiments, touch screen data can include data representing taps and/or movements such as swipes, pinches, drags, and other gestures. In some embodiments, touch screen data can be sent in raw data format (e.g., a sequence of coordinates representing where pressure corresponding to a finger movement was detected). In other embodiments, touch screen data can be converted into processed data, such as gesture events (e.g., a tap, a swipe or drag from one point to another, a pinch, etc.) prior to being sent to an accessory. In some embodiments, raw keyboard data can be sent to an accessory and/or processed keyboard data can be sent to an accessory. In some embodiments, some or all types of user input data can be communicated to accessory 202 using an application and application protocol, e.g., as described below; in other embodiments, some or all types of user input data can be communicated using the accessory communication protocol to whatever extent the accessory communication protocol supports sending user input data of a particular type.

Mobile computing device 200 can also send information other than user input to accessory 202. For example, in some embodiments mobile computing device 200 can include various sensors and/or data gathering devices in addition to user input devices; examples can include accelerometers, gyroscopes, compass, location-determining devices (e.g., a Global Positioning System receiver or telephonic triangulation system), light sensors, infrared sensors, camera, network interfaces (e.g., telephone, WiFi, Bluetooth), or the like. Mobile computing device 200 can provide any or all of this data to accessory 202, e.g., in response to a specific request from accessory 202. In some embodiments, some or all of this data can be communicated to accessory 202 using an application and application protocol, e.g., as described below; in other embodiments, some or all of this data can be communicated using the accessory communication protocol to whatever extent the accessory communication protocol supports sending information of a particular type.

To facilitate exchange of messages, an accessory and an application can use a mutually agreed-upon application protocol. The application protocol can specify a universe of accepted formats for messages that can be exchanged. Devices or programs adhering to a particular application protocol can structure the messages they send in accordance with the application protocol's universe of accepted formats and can interpret messages they receive in accordance with the application protocol's universe of accepted formats. For instance, in the case of binary digital communication, the application protocol can specify how the bits comprising the message are to be interpreted by the recipient. Indeed, in some embodiments, portions of the accessory communication protocol can be directly adopted as all or part of an application protocol for a particular accessory and/or application.

An application communication protocol can be developed, for example, by the developer of the application and/or accessory. In some embodiments, an application communication protocol can include application and/or accessory specific commands, data structures, etc. Furthermore, the terms “application communication protocol” and “application protocol” can be used interchangeably. The terms “accessory communication protocol”, “accessory communication protocol”, “general communication protocol”, and “general protocol” can also be used interchangeably.

In certain embodiments described herein, application protocol messages can be sent between devices by encapsulating, wrapping, or packaging the messages within packets conforming to the accessory communication protocol, e.g., using tunneling commands as described above. Thus, the transport link specified by the accessory communication protocol can be used, and it is not necessary for an application protocol to specify a physical transport link.

Launching Processes

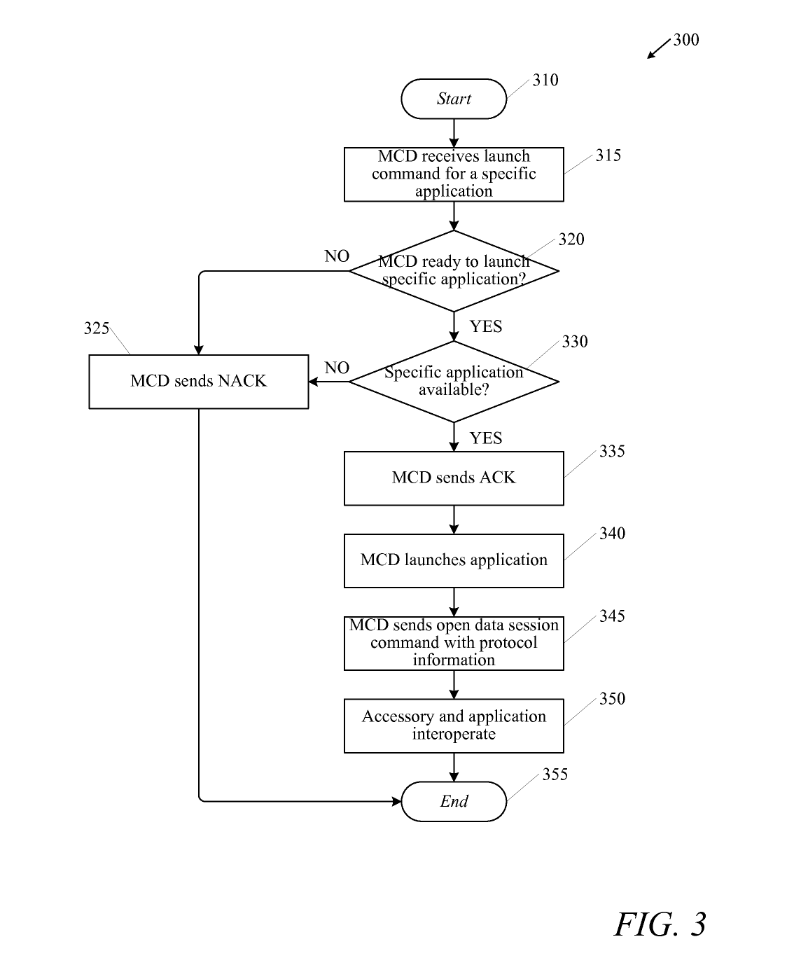

In some embodiments of the invention, an accessory can request that a mobile computing device launch a specific application. Various techniques are described herein for making such a request. FIG. 3 shows a flowchart of process 300 that can be executed by a mobile computing device (indicated as MCD in the figures) when an accessory requests launching an application according to some embodiments.

Process 300 starts at block 310. At block 315 the mobile computing device can receive a launch command indicating a specific application that the accessory would like to interoperate with the mobile computing device. In some embodiments, the launch command can be part of the general lingo described above or part of a specific lingo. The launch command can specify a specific application; for example, a Launch command can be used that can include the name of the specific application, a bit mask that indicates a specific application, a code corresponding to the specific application, a reverse domain name associated with the specific application, or any other information that can identify the specific application. The command can be sent from the accessory to the mobile computing device through a wired or wireless channel.

At block 320 process 300 can determine whether the mobile computing device is in a state to launch an application. At block 320 various states of the mobile computing device can restrict execution of the specific application. The following examples are illustrative. As a first example, if an application is currently executing at the mobile computing device, then the mobile computing device may not be in a state to allow launching of an application. In some situations, the operating system of the mobile computing device may permit background applications to execute while another application is executing in the foreground. In some embodiments, the user may be queried through the user interface to choose whether to allow the application to launch. In such situations, the mobile computing device may permit launching of the specific application if the user chooses to allow it. As another example, if another accessory has requested launch of another application and that application is executing, then the mobile computing device may not permit launch of the requested application. As yet another example, at block 320 the user may be queried whether to allow the specific application to be launched. This query may occur, for example, through user interface 235 of FIG. 2. The mobile computing device can restrict or deny launch of an application for various other reasons without limitation.

If the mobile computing device is not in a state that allows execution of an application, then process 300 proceeds to block 325. Otherwise process 300 proceeds to block 330.

At block 330 process 300 can determine whether the specific application is available for execution at the mobile computing device. For example, a lookup table can be maintained in memory (e.g., storage device 225) that includes a listing of all the applications available for execution at the mobile computing device. This lookup table, for example, can list the applications by application name, identifier, id number, application protocol identifier, or reverse domain name convention. Process 300, for example, can compare application identifying information (e.g., specific application name) with the application information in the lookup table. If there is a match, then the application is available and process 300 can proceed to block 335. If not, process 300 proceeds to block 325. In some embodiments, like all blocks, block 320 and 330 can be interchanged, combined in a single block, and/or expanded into multiple blocks.

If the mobile computing device is not ready to launch the requested application or if the requested application is not available then at block 325, the mobile computing device can send a launch denial message to the accessory. Such a message can be a negative acknowledgement (NACK) message or a LaunchDenied command sent in response to the launch command. The NACK message can be an agreed upon negative acknowledgement message and/or be part of the general lingo. The LaunchDenied command, for example, can be a command with or without a payload or data. Either way the message can convey to the accessory that the application cannot be launched by the mobile computing device. In some embodiments, the message can specify the reason why the application was not launched. Following block 325, process 300 ends at block 355.

If the mobile computing device is ready to launch the requested application and the application is available at the mobile computing device, then at block 335 the mobile computing device can positively acknowledge the launch command—for example, by sending an acknowledgement (ACK) message or a LaunchPermitted message to the accessory. The message can convey to the accessory that the application can be launched by the mobile computing device.

In some embodiments, the message can convey that while the application can be launched by the mobile computing device, it may not necessarily launch in response to the request. In such embodiments, the application may launch solely at the discretion of the mobile computing device at block 340. The mobile computing device can then send a command to the accessory setting up a session between the application and the accessory at block 345. The communication session can be created by the mobile computing device and can provide various functions and/or settings. These functions and/or settings can be used by either or both the mobile computing device and the accessory for setting up a communication session. The command can include the communication session ID and/or communication protocol information. For example, the command can identify an application protocol to be used and/or indicate that messages can be exchanged using tunneling commands of the accessory protocol described above.

At block 350 the accessory can interoperate with the application using the communication session. For example, messages, data, commands and the like can be sent between the application and accessory. In some embodiments, data from the accessory can be sent to the application for presentation to a user through a user interface. In some embodiments, user input, configuration, and/or control information can be sent to the accessory from the application. Various other data, messages, and/or commands can also be sent. At block 355 process 300 can end. For example, process 300 can end when the accessory is disconnected from the mobile computing device, when the mobile computing device is placed in airplane mode, when an indication to end communication is indicated by a user through the application interface and/or when the application is closed.

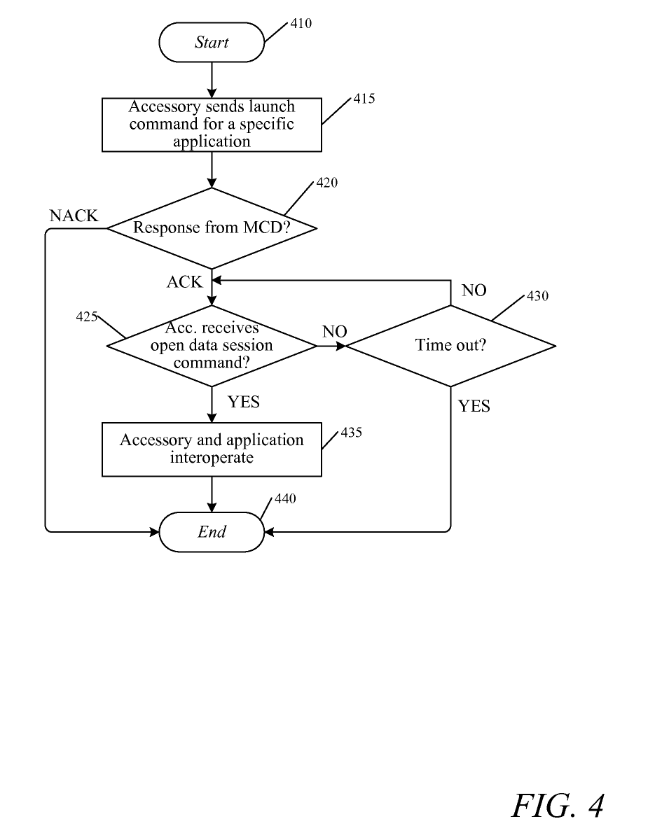

FIG. 3 describes a launch process from the mobile computing device perspective. FIG. 4 shows a launch process from the accessory's perspective. That is, the figure shows process 400 for an accessory (e.g., accessory 202) to request launch of an application at a mobile computing device (e.g., mobile computing device 200) according to some embodiments of the invention. Process 400 begins at block 410. At block 415 the accessory sends a launch command to the mobile computing device. This command can be the Launch command described above in regard to FIG. 3. In this embodiment, the launch command can specify a specific application. The accessory can then wait for a response from the mobile computing device. In some embodiments, the accessory can wait a predetermined period of time prior to timing out and ending when no response is received.

In some embodiments, the accessory can send a Launch command to the mobile computing device soon after the accessory is connected with the mobile computing device. In some embodiments, the accessory can send the Launch command after identification, handshaking, authentication, capabilities identification, and/or initialization processes have occurred. In other embodiments, the Launch command can be sent as part of the capabilities identification process. In some embodiments, the Launch command can be sent from the accessory to the mobile computing device in response to an interaction with a user at the accessory. Moreover, some accessories may request launch of one application in response to one interaction with a user and launch of a second application in response to a different interaction with a user. Thus, the accessory may request the launch of different applications on different conditions such as accessory interactions with a user, environmental interactions, network interactions, environmental conditions, etc.

At block 420 a response has been received. This response can be either a positive acknowledgement (e.g., ACK) or a negative acknowledgement (e.g., NACK). If a negative acknowledgement has been received, then process 400 ends at block 440. If a positive acknowledgement is received, then process 400 proceeds to block 425. Although a positive acknowledgement has been received, such an acknowledgement may not necessarily indicate that the application has been launched. Moreover, in some embodiments, the accessory does not necessarily begin communicating with the mobile computing device after receipt of the positive acknowledgment.

At block 425 the accessory can determine whether it has received a command to set up a communication session between the specific application executing at the mobile computing device and the accessory. This command, in part, can indicate that the specific application is ready to communicate with the accessory. The communication session can provide various communication functions and/or the necessary information needed for the accessory to communicate with the mobile computing device. The command can include the communication session ID and/or communication protocol information among other information. Upon receipt of the open communication command, the accessory can open a communication session with the mobile computing device.

If an open communication session command has not been received by the accessory, then process 400 can move to block 430. After a predetermined period of time has passed since the accessory received the positive acknowledgement, then process 400 may time out and end at block 440. Otherwise, process 400 returns to block 425 and blocks 430 and 425 repeat until a response is received or until the predetermined period of time elapses.

If an open communication session command has been received at block 425, then process 400 proceeds to block 435. A communication session can be established according to the parameters received from the mobile computing device and the two devices can interoperate at block 435. At block 440, process 400 can end. Process 400 can end, for example, when the accessory is disconnected from the mobile computing device, when the mobile computing device is placed in airplane mode, when an indication to end communication is indicated by a user through the user interface, and/or when the application is closed.

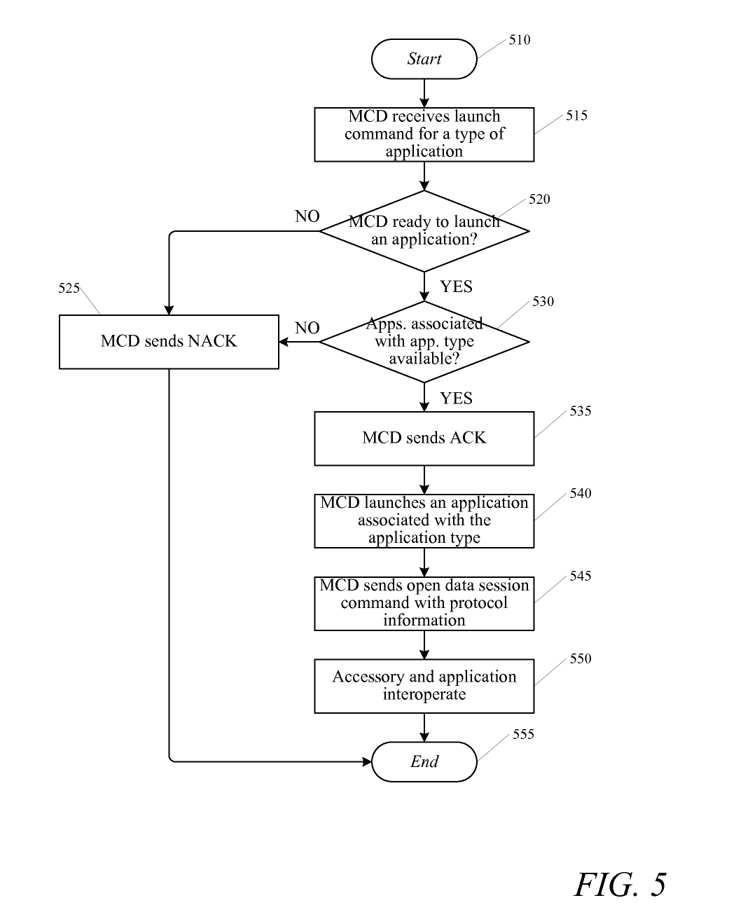

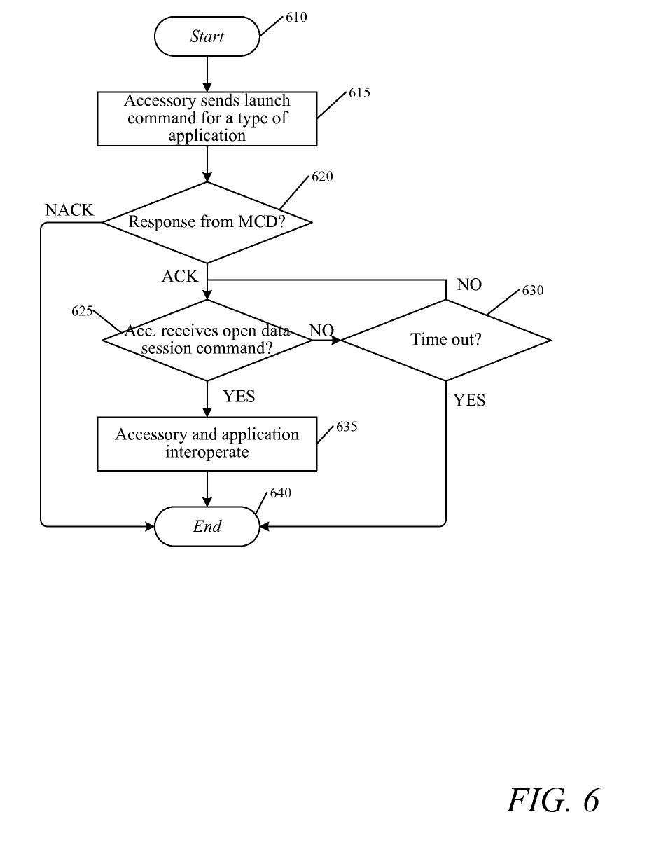

The processes described in FIG. 3 and FIG. 4 describe launching of a specific application from the perspective of the mobile computing device and the accessory. FIG. 5 and FIG. 6 describe similar processes where an accessory requests the launch of an application type (or genus). For example, an application may have a free version, a trial version, a pro version, and/or a full version of the application. Rather than requesting one of these specific applications, an accessory can specify an application type that permits the mobile computing device to launch one of these applications; for example, the highest priority version available. As another example, an accessory may be impartial as to the creator of the application, the application status, or the application level. For example, the accessory may request an application with a specific characteristics, such as, maps, calendars, audio output, video output, etc. Instead, the accessory may be able to interact with any of a number of different applications. Turning first to FIG. 5, this figure shows a flowchart of process 500 that can be used to launch an application on a mobile computing device in response to a request from an accessory according to some embodiments of the invention.

Process 500 starts at block 510. At block 515, the mobile computing device can receive a launch command for an application type. The launch command can be part of the general lingo described above or part of a specific lingo. An application type can include a group of applications that can be launched by the mobile computing device and interoperate with the accessory. For example, the Launch command can include the name of an application type; a genus of applications; the name of the accessory, which can be used to look up application types in a lookup table; a communication protocol that corresponds with the available protocols usable by the accessory; a bit mask that indicates a type of application or accessory; a code corresponding to the application type; or any other information that can identify an application type. In any of the embodiments described herein, a reverse domain name convention can be used to indicate either a specific application or an application type. An example of this naming convention is described below.

At block 520, process 500 can determine whether the mobile computing device is in a state to launch an application. If the mobile computing device is not in a state that allows execution of an application, then process 500 proceeds to block 525. Otherwise process 500 proceeds to block 530. Block 520 can be similar to block 320.

At block 530, process 500 can determine whether applications associated with the application type are available for execution at the mobile computing device. If an application associated with the application type is available, process 500 can proceed to block 535. If unavailable, process 500 proceeds to block 525. For example, a lookup table can be maintained in memory (e.g., storage device 225) that includes a listing of all the applications available for execution at the mobile computing device and each application's application type(s). This lookup table, for example, can list the applications by application name, identifier, id number, application type, or reverse domain name convention or application protocol name. Process 500, for example, can compare the application type information received in the launch command with the application type(s) listed in the lookup table. If there is a match, then an application is available and process 500 can proceed to block 535. If unavailable, process 500 proceeds to block 525. In some embodiments, block 520 and 530 can be interchanged, combined in a single block, and/or expanded into multiple blocks. In some embodiments, multiple applications can be found that correspond with the application type included in the launch command. In some embodiments, these applications can be prioritized (e.g., within the lookup table) and the highest priority application can be considered for launching. In some embodiments, if multiple applications with the same application type are found, then the user may be prompted to select one of the applications.

At block 525, the mobile computing device can send a launch denial message to the accessory. Such a message can be a negative acknowledgement (NACK) message or an LaunchDenied command in response to the launch command. The NACK message can be the agreed upon negative acknowledgement message or part of the general lingo. The LaunchDenied command, for example, can be a command with or without a payload or data. Either way, the message can convey to the accessory that the application cannot be launched by the mobile computing device. In some embodiments, the message can specify the reason why the application was not launched. Following block 525, process 500 ends at block 555.

At block 535, the mobile computing device can positively acknowledge the launch command; for example, by sending an acknowledgement (ACK) message to the accessory or a LaunchPermitted message. The message can convey to the accessory that the application can be launched by the mobile computing device.

In some embodiments, the message can convey that while the application can be launched by the mobile computing device, it may not necessarily launch in response to the request. In such embodiments, the application may launch solely at the discretion of the mobile computing device at block 540. The mobile computing device can then send a command to the accessory, setting up a communication session between the application and the accessory at block 545. The communication session can be created by the mobile computing device and provides various communication functions for the mobile computing device to communicate with the accessory. The command can include the communication session ID, communication protocol information, and/or identification of the specific application that has launched in response to the launch command (e.g., using reverse domain name convention as described below).

At block 550, the accessory can interoperate with the application using the communication session. At block 555, process 500 can end. For example, process 500 can end when the accessory is disconnected from the mobile computing device, when the mobile computing device is placed in airplane mode, when an indication to end communication is indicated by a user through the application interface, and/or when the application is closed.

While FIG. 5 describes a launch process from the mobile computing device perspective, FIG. 6 shows a launch process from the accessory's perspective. That is, the figure shows process 600 for an accessory (e.g., accessory 202) requesting launch of an application type at a mobile computing device (e.g., mobile computing device 200) according to some embodiments of the invention. Process 600 is similar to process 400 shown in FIG. 4 and begins at block 610. At block 615, the accessory sends a launch command to the mobile computing device. This command can be the Launch command described above in regard to FIG. 3, FIG. 4, or FIG. 5. In this embodiment, the launch command can specify an application type. The accessory can then wait for a response from the mobile computing device. In some embodiments, the accessory can wait a predetermined period of time prior to timing out and ending when no response is received.

At block 620 a response can be received. This response can be either a positive acknowledgement (e.g., ACK) or a negative acknowledgement (e.g., NACK). If a negative acknowledgement has been received, then process 600 ends at block 640. If a positive acknowledgement is received then process 600 proceeds to block 625. Although a positive acknowledgement has been received, such an acknowledgement may not necessarily indicate that the application has been launched.

At block 625 the accessory can determine whether it has received a command setting up a communication session between an application executing at the mobile computing device and the accessory. This command can indicate that the application associated with the application type that was launched at the mobile computing device is ready to communicate with the accessory. The communication session can provide various communication functions and/or information necessary for the accessory to communicate with the mobile computing device. The command can include the communication session ID and/or communication protocol information among other information.

If an open communication session command has not been received by the accessory, then process 600 can move to block 630. If a predetermined period of time has passed since the accessory received the positive acknowledgement, then process 600 can time out and end at block 640. Otherwise, process 600 can return to block 625.

If an open communication session command has been received at block 625, then process 600 proceeds to block 635. A communication session can be established according to the parameters received from the mobile computing device and the two devices can interoperate at block 635. At block 640, process 600 can end. For example, the process can end when the accessory is disconnected from the mobile computing device, when the mobile computing device is placed in airplane mode, when an indication to end communication is indicated by a user through the application interface, and/or when the application is closed.

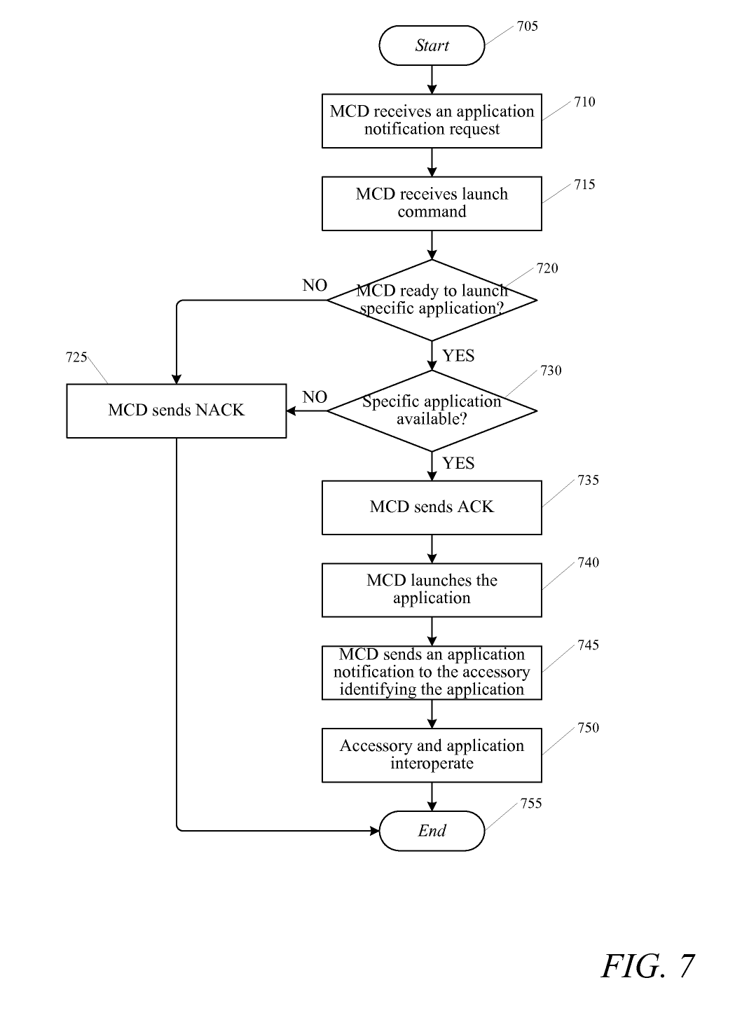

FIG. 7 shows process 700, which can be carried out at a mobile computing device, when an accessory requests launching of an application. Process 700 in some respects is similar to process 300 shown in FIG. 3 and process 500 shown in FIG. 5. Process 700 starts at block 705 and an application notification request can be sent at block 710. This request can indicate that the accessory would like to receive notification from the mobile computing device when a new application is launched or is terminated. This request can be a command that is part of the general lingo or is part of a specific lingo. In response to the command, the mobile computing device can send either a positive or negative acknowledgement to the accessory indicating that it will either comply with the request or not comply with the request. In some embodiments, the application notification request can be used to indicate which application is currently executing. In some embodiments, the mobile computing device can notify the accessory when an application is newly launched, when an application has been moved from foreground processing to background processing, and/or when an application is moved from background processing to foreground processing.

Following block 710, process 700 can follow a path similar to process 300 or process 500 until block 745. That is, block 715 can be similar to blocks 315 or 515. Block 720 can correspond to blocks 320 or 520. Block 725 can be similar to blocks 325 or 525. Block 730 can correspond to blocks 330 or 530. Block 735 can be similar to blocks 335 or 535. Block 740 can correspond to blocks 340 or 540. At block 745, the mobile computing device can send an application notification to the accessory. This application notification can be sent in response to the specific application being launched at the mobile computing device and can specify the application that was launched. The application can be specified using the application name or an application identifier (e.g., using reverse domain name convention). In response, the mobile computing device can receive a communication session request from the accessory. This request can indicate to the mobile computing device that the accessory would like to open a communication session with the application. In response thereto, the mobile computing device can open a communication session for the accessory and the application. In other embodiments, block 745 can be similar to block 345 or block 545 where a communication session can be opened between the application and the accessory.

At block 750, the application and accessory can interoperate using the communication session. At block 555, process 500 can end. For example, process 500 can end when the accessory is disconnected from the mobile computing device, when the mobile computing device is placed in airplane mode, when an indication to end communication is indicated by a user through the application interface and/or when the application is closed.

Although the notification request received at block 710 is described above as an “application launch” notification request, in certain embodiments this notification request can be a type of request that is used in other contexts other than the application launching context. For example, the notification request can be a request by the accessory to be notified when an application begins music playback, or when the application undergoes some other state change or event. In the “music playback” example, the application can start music playback after launch and send an notification to the accessory indicating that it is now playing music. Upon receiving the notification, the accessory can determine that the application has been launched and can take appropriate action to interoperate with the application (e.g., send a communication session request, etc.).

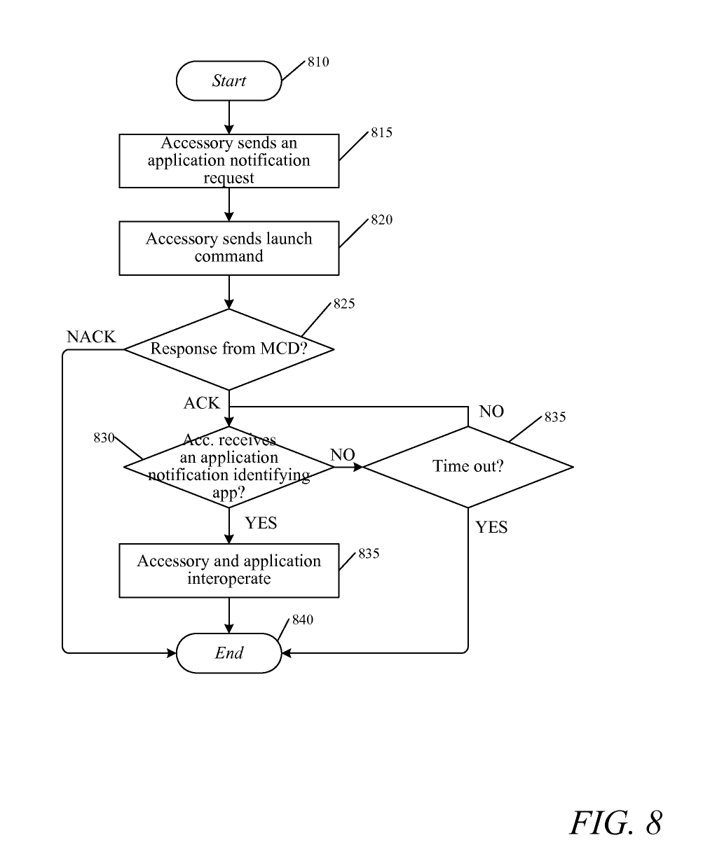

FIG. 8 shows process 800 that can be carried out by an accessory when the accessory requests launch of an application. Process 800 is similar in some respects to process 400 shown in FIG. 4 and process 600 shown in FIG. 6. Process 800 begins at block 810. At block 815, the accessory can send an application notification request at block 815. This application notification request can be the application notification request received by the mobile computing device at block 710 of FIG. 7. Block 820 can correspond to blocks 420 or 620, and block 825 can correspond to blocks 425 or 625. At block 830 the accessory can receive an application notification that indicates that the application has been launched. In response thereto the mobile computing device and the accessory can open a communication session and begin to interoperate at block 835.

At block 840 process 800 can end. For example, process 800 can end when the accessory is disconnected from the mobile computing device, when the mobile computing device is placed in airplane mode, when an indication to end communication is indicated by a user through the application interface, and/or when the application is closed.

In some embodiments, processes 300, 500, and/or 700 can be executed by processor 230 of the mobile computing device 200 shown in FIG. 2. The communication between accessory and the mobile computing device can occur using accessory I/O 205. Furthermore, processes 400, 600, and/or 800 can be performed by controller 260 of accessory 202. And the communication between the accessory and the mobile computing device can occur using mobile computing device I/O 250.

In further embodiments, the mobile computing device can determine if a specific application or a type of application is available at the mobile computing device for execution (e.g., blocks 330, 530, and 730). If the specific application or an application corresponding to the application type is not available at mobile computing device, the mobile computing device can download the application from a network location. For example, the application identifying information or application type identifying information can be sent to an application store where such an application can be downloaded. In some embodiments, an application can be automatically downloaded. In other embodiments, the user can be queried if he or she would like to download the application. If the user approves, then the application can be downloaded and executed at the mobile computing device.

In further embodiments, the accessory can request information about the available applications that can be executed on the mobile computing device prior to sending a launch command. For example, an AvailableApplicationRequest command can be sent to the mobile computing device from the accessory. In response, the mobile computing device can send an AvailableApplication message to the accessory. This message can include a payload that lists all the applications available at the mobile computing device that can be accessed by the accessory. The payload can also include other information associated with the available applications, such as application icons and the like. This list can be ordered in a manner consistent with the order of applications within a lookup table at the mobile computing device. In some embodiments, this list may not be a complete list of all the applications, as some applications may not be available or compatible for communication with an accessory. Using this list, the accessory can then request launch of one of the applications knowing that the application exists and is available to the mobile computing device. In doing so, the launch request can then include a bit mask that includes an asserted bit that corresponds with the application in the list of applications. The mobile computing device can simply identify the application by noting the placement of the asserted bit in relation to the list of applications.

In further embodiments, the mobile computing device can automatically launch an application upon establishing a connection with an accessory, without receiving an explicit launch command from the accessory. For example, upon connecting to the accessory, the mobile computing device can access a lookup table to determine one or more applications that are compatible with the accessory. The mobile computing device can then automatically launch one of the compatible applications. In cases where multiple applications are deemed to be compatible with the accessory, the mobile computing device can select an application to be launched based on a priority ranking, or can request a user to select a particular application from the set of compatible applications.

In further embodiments, the launch command sent from the accessory to the mobile computing device can include information indicating whether the application is to be launched exclusively in the foreground or exclusively in the background. For example, the accessory may be set to a low power mode where it only wants to communicate with the application in the background. One of ordinary skill in the art would recognize other variations, modifications, or alternatives.

Reverse Domain Name Convention

In some embodiments, a reverse domain name convention can be adopted for managing the application namespace. Conventional domain names provide, from left to right, lower level domains to top level domains. For example, in the domain name: “help.example.com”, the term “com” is the top level domain and the term “example” is a lower level domain, and the term “help” is the lowest level domain. As another example, the domain name “mac.apple.com” from left to right specifies the lowest level domain “mac”, the middle domain “apple”, and the top level domain “com”. Reverse domain names, on the other hand, would provide “com.apple.mac”.

The reverse domain name convention can be used to specify applications used by a specific company. That is, the reverse domain name “com.company1.application1” specifies that the “application1” application is associated with the company (or other developer) “company1”. Thus, in general, a company can implement an application using the reverse domain name convention, where the first portion of the reverse domain name references the company (“com.company1”) and is associated with the company's (or other developer's) Internet domain name. The second portion of the reverse domain name (“application1”) refers to a specific application. To the extent that the different developers of accessories and/or applications are associated with different Internet domain names, a reverse domain name convention allows developers to distinguish applications and/or accessories from others by naming their protocols based on the reverse of their Internet domain name. This convention allows developers to independently name their applications without concern for the naming conventions of other developers. Moreover, if there is a conflict between two developers using the same names, a simple check of who owns the corresponding Internet domain name should determine which developer has rights to a particular reverse domain name.

In some embodiments, reverse domain names can be appended to include a global identifier that is specific to all devices in a class of devices or specific to all applications in a class of applications. For instance, all speaker accessories can include an identifier appended to the reverse domain name. For example, such a reverse domain name may have the following format: “com.company1.accessory1.speaker” or “speaker.com.company1.accessory1.” With such a convention, different companies can produce speakers and yet the mobile computing device can recognize such devices as speakers despite manufacturer differences. As another example, a reverse domain name may have the following format: “com.company1.accessory1.application1”. This reverse domain name specifies a specific application that can be used by an accessory to request auto launching of the specific application (see FIG. 3 and FIG. 4). As another example, a reverse domain name may have the following format: “com.company1.accessory1”. This reverse domain name specifies a specific accessory that may be used with a set of applications or a single application. And it can be used by an accessory to request launching of the specific application associated with accessory 1 (see FIG. 3 and FIG. 4) or any of the application types associated with accessory 1 (see FIG. 5 and FIG. 6). As another example, a reverse domain name may have the following format: “com.company1.applicationtype1”. This reverse domain name specifies a specific application type that may refer to a genus of applications that can interoperate with an accessory (see FIG. 5 and FIG. 6). A mobile computing device can then launch any of the applications associated with this application type. Various other combinations and variations of these examples can be used.

The reverse domain name convention is only one example of how application protocols can be identified. Any type of convention can be used.

Embodiments of the present invention can be realized using any combination of dedicated components and/or programmable processors and/or other programmable devices. The various processes described herein can be implemented on the same processor or different processors in any combination. Accordingly, where components are described as being configured to perform certain operations, such configuration can be accomplished, e.g., by designing electronic circuits to perform the operation, by programming programmable electronic circuits (such as microprocessors) to perform the operation, or any combination thereof. Processes can communicate using a variety of techniques including, but not limited to, conventional techniques for interprocess communication, and different pairs of processes may use different techniques, or the same pair of processes may use different techniques at different times. Further, while the embodiments described above may make reference to specific hardware and software components, those skilled in the art will appreciate that different combinations of hardware and/or software components may also be used and that particular operations described as being implemented in hardware might also be implemented in software or vice versa.

Computer programs incorporating various features of the present invention may be encoded on various computer readable storage media; suitable media include magnetic disk or tape, optical storage media such as compact disk (CD) or DVD (digital versatile disk), flash memory, and the like. Computer readable media encoded with the program code may be packaged with a compatible electronic device, or the program code may be provided separately from electronic devices (e.g., via Internet download).

Thus, although the invention has been described with respect to specific embodiments, it will be appreciated that the invention is intended to cover all modifications and equivalents within the scope of the following claims.

What is claimed is:

1. A method comprising:
sending a launch command from an accessory to a mobile computing device, wherein the launch command includes information associated with one or more applications that are to be executed by the mobile computing device;
receiving, by the accessory, an acknowledgement message from the mobile computing device indicating that an application associated with the information included within the launch command is available for execution at the mobile computing device; and
receiving, by the accessory, an open session message from the mobile computing device separately from the acknowledgement message indicating that a communication session has been opened for communication between the accessory and the mobile computing device.

2. The method according to claim 1 further comprising communicating, by the accessory, with the mobile computing device.

3. The method according to claim 2, wherein the information included in the launch command specifies a specific application, wherein the acknowledgement message indicates that the specific application is available for execution at the mobile computing device, wherein the open session message indicates that a communication session has been opened for communication with the specific application executing at the mobile computing device; and wherein the communication with the mobile computing device includes communicating with the specific application executing at the mobile computing device.

4. The method according to claim 1, wherein in the event the accessory receives a negative acknowledgement command thereafter ceasing communication with the mobile computing device.

5. The method according to claim 2, wherein the information included in the launch command specifies a communication protocol, wherein the acknowledgement message indicates that an application is available for execution at the mobile computing device that is compatible with the communication protocol, wherein the open session message indicates that a communication session has been opened for communication with a specific application executing at the mobile computing device using the communication protocol, and wherein the communication with the mobile computing device includes communicating with the specific application executing at the mobile computing device using the communication protocol.

6. The method according to claim 2, wherein the information included in the launch command specifies an application type, wherein the acknowledgement message indicates that an application is available for execution at the mobile computing device that is consistent with the application type, wherein the open session message indicates that a communication session has been opened for communication with a specific application executing at the mobile computing device, and wherein the communication with the mobile computing device includes communicating with the specific application executing at the mobile computing device.

7. An accessory for use with a mobile computing device, the accessory comprising:
an input/output interface configured to exchange commands and data with the mobile computing device; and
a controller coupled with the input/output interface, the controller being configured to:
detect connection of the mobile computing device with the input/output interface;
send a launch command to the mobile computing device through the input/output interface, the launch command including an indication associated with an application to launch at the mobile computing device;
receive an open communication message from the mobile computing device through the input/output interface indicating that a communication session has been opened for communication with a specific application.

8. The accessory of claim 7 wherein the controller is further configured to interoperate with the specific application executing at the mobile computing device.

9. The accessory according to claim 7 wherein the controller is further configured to receive an acknowledgement from the mobile computing device indicating that the mobile computing device can launch the application indicated by the launch command.

10. The accessory according to claim 7 wherein the indication associated with an application includes an indication of one or more communication protocols associated with one or more applications.

11. The accessory according to claim 7 wherein the indication associated with an application includes an indication of an application type, and the specific application is an application associated with the application type.

12. The accessory according to claim 7 wherein the indication associated with an application includes an indication of a specific application.

13. The accessory according to claim 7 wherein the open communication message includes an indication of a communication protocol compatible with the specific application.

14. A method for use in a mobile computing device, the method comprising:
receiving a launch command from an accessory coupled with the mobile computing device, wherein the launch command includes application information associated with one or more applications;
determining whether an application associated with the application information is available at the mobile computing device;
in the event an application associated with the application information is not available at the mobile computing device, sending a message to the accessory denying the launch command; and
in the event an application associated with the application information is available at the mobile computing device thereafter:
sending an acknowledgement that an application associated with the application is available;
launching an application associated with the application information;
opening a communication channel between the application and the accessory; and
sending a message to the accessory indicating that the communication channel has been opened.

15. The method according to claim 14, wherein the message sent to the accessory indicating that a communication channel has been opened includes an indication of a communication protocol.

16. The method according to claim 14, wherein the application information includes one or more of the following: a specific application, an application type, a communication protocol, and an indication of the application creator.

17. The method according to claim 14 further comprising determining whether the mobile computing device can launch an accessory associated with the application information.

18. A non-transitory computer-readable medium having stored instructions thereon, which, when executed by a processor of a mobile computing device, causes the processor to perform operations comprising:
receiving an indication from an accessory to launch an application;
determining whether the mobile computing device is in a state to launch the application;
in the event the mobile computing device is not in a state to launch the application sending a message to the accessory indicating that launch of the application is not possible; and
in the event the mobile computing device is in a state to launch the application:
executing the application;
opening a communication channel between the application and the accessory; and
sending a message to the accessory with an indication that the communication channel has been opened.

19. The computer-readable medium according to claim 18, wherein the operations further comprise sending an acknowledgement to the accessory in the event the mobile computing device is in a state to launch the application.

20. The computer-readable medium according to claim 18, wherein determining whether the mobile computing device is in a state to launch the application includes determining whether the application is available at the mobile computing device for execution.

21. The computer-readable medium according to claim 18, wherein determining whether the mobile computing device is in a state to launch the application includes determining whether the mobile computing device is currently executing an incompatible application.

22. The computer-readable medium according to claim 18, wherein determining whether the mobile computing device is in a state to launch the application includes determining whether the mobile computing device is in a state to launch the application as a background process.
